(19) United States
(12) Patent Application Publication
(10) Pub. No.: US 2025/0156833 A1
(43) Pub. Date: May 15, 2025

(54) DYNAMIC TRANSACTION SYSTEM

(71) Applicant: Matthew Bresler, Henderson, NV (US)

(72) Inventor: Matthew Bresler, Henderson, NV (US)

(21) Appl. No.: 18/946,787

(22) Filed: Nov. 13, 2024

Related U.S. Application Data
(60) Provisional application No. 63/548,358, filed on Nov. 13, 2023.

(51) Int. Cl. G06Q 20/22; G07F 17/32

(52) U.S. Cl. CPC G06Q 20/227; G07F 17/3258

(57) ABSTRACT

Methods and systems for providing a dynamic transaction system. A first plurality of transaction options associated with a first plurality of events are presented, and a request to initiate a transaction on a first event associated with a first transaction option is received. A result of the first transaction option is determined based on a result of the first event. On condition that the result of the first transaction option is successful, an option is presented to either execute a potential payout for the first transaction option or continue the transaction. On condition that continuing the transaction is selected, a second plurality of transaction options associated with a second plurality of events is presented for constructing a series including the first transaction option and a second transaction option of the second plurality of transaction options.

### CROSS-REFERENCE TO RELATED APPLICATION

This application claims the benefit of U.S. Provisional Application Ser. No. 63/548,358 filed Nov. 13, 2023, which is hereby incorporated herein by reference in its entirety.

### BACKGROUND

Known transaction systems offer limited opportunities for participants to stay engaged and adapt their strategies based on changing circumstances or new insights, resulting in a less dynamic experience. For instance, traditional parlay systems in sports betting are rigid, structured around a fixed number of bets or “legs” that are determined when a wager is placed. Once the wager is placed, there are typically no more meaningful betting decisions to make, leading to a largely passive betting experience. Additionally, to mitigate risk and ensure fairness, at least some known parlay systems restrict the bundling of highly correlated bets into a single transaction, limiting participants' ability to tailor their experience. Similarly, traditional jackpot or prize pool systems are inflexible because the conditions required to qualify for a jackpot or prize pool reward are typically fixed. Moreover, traditional jackpot or prize pool systems are not allocated based on skill, but rather on random number generators. As a result, participants usually have little or no control over their chances of winning. While tiered and/or progressive jackpot or prize pool systems attempt to add variety by introducing additional layers of rewards and escalating jackpots or prize pools, they too are often constrained by predefined paths and rigid structures, both in their form and within regulatory frameworks.

### SUMMARY

The present disclosure enables transaction systems to provide greater flexibility, variety, and engagement. In one aspect, a method is provided for providing a dynamic transaction system. The method includes presenting a first plurality of transaction options associated with a first plurality of events and receiving a request to initiate a transaction on a first event of the first plurality of events. The request is associated with a first transaction option of the first plurality of transaction options. A result of the first transaction option is determined based on a result of the first event. On condition that the result of the first transaction option is successful, an option is presented to either execute a potential payout for the first transaction option or continue the transaction. On condition that continuing the transaction is selected, a second plurality of transaction options associated with a second plurality of events is presented for constructing a series including the first transaction option and a second transaction option of the second plurality of transaction options.

In another aspect, a system is provided for providing a dynamic transaction system. The system includes a user device, and a server system that communicates with the user device to present, to a participant associated with the user device, a first plurality of transaction options associated with a first plurality of events, and receives, from the user device, a request to initiate a transaction on a first event of the first plurality of events. The request is associated with a first transaction option of the first plurality of transaction options. The server system determines a result of the first transaction option based on a result of the first event. On condition that the result of the first transaction option is successful, the server system communicates with the user device to present, to the participant associated with the user device, an option to either execute a potential payout for the first transaction option or continue the transaction. On condition that continuing the transaction is selected, the server system communicates with the user device to present, to the participant associated with the user device, a second plurality of transaction options associated with a second plurality of events for constructing a series including the first transaction option and a second transaction option of the second plurality of transaction options.

In yet another aspect, a computing system is provided for providing a dynamic transaction system. The computing system includes a processor, and a computer-readable memory comprising one or more instructions for causing the processor to determine a first plurality of transaction options associated with a first plurality of events, and receive a request to initiate a transaction on a first event of the first plurality of events. The request is associated with a first transaction option of the first plurality of transaction options. The processor determines a result of the first transaction option based on a result of the first event. On condition that the result of the first transaction option is successful, the processor presents an option to either execute a potential payout for the first transaction option or continue the transaction. On condition that continuing the transaction is selected, the processor determines a second plurality of transaction options associated with a second plurality of events for constructing a series including the first transaction option and a second transaction option of the second plurality of transaction options.

Other aspects and features of the present disclosure will be in part apparent and in part pointed out herein. This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail below with reference to the attached drawing figures, wherein:

FIG. 1 is a block diagram illustrating an example system for providing a dynamic transaction system;

FIG. 2 is a block diagram illustrating an example server that may be used in a system, such as the system of FIG. 1;

FIG. 3 is a flowchart illustrating an example method for providing a dynamic transaction system;

FIG. 4 is a flowchart illustrating an example method for providing a prize pool system;

FIG. 5 is a computer architecture diagram illustrating an computing system that may be used to perform one or more computing operations described herein, such as those implemented by the system of FIG. 1, the server of FIG. 2, or the method of FIGS. 3 and 4.

Corresponding reference numbers indicate corresponding parts throughout the drawings.

### DETAILED DESCRIPTION

According to various aspects of the present disclosure, an enhanced transactional platform provides a dynamic transaction system to deliver an engaging experience with dynamic reward opportunities. Examples described herein allow a new bet or “leg” to be added after the resolution of each leg. This promotes participant engagement and retention by offering opportunities to capitalize on real-time events and participant intuition and introducing a layer of strategic depth to transactional decisions that leverages the dynamic, unpredictable nature of real-life events. Additionally, engagement and retention may be fostered by providing participants the ability to unlock prize pool payouts based on strategic transactional choices.

Although some examples described herein may be presented in the context of gaming and sports betting, it will be understood that the methods and systems disclosed herein are broadly applicable to many transactional environments. For example, the dynamic transaction system described herein may be implemented in financial systems, exchanges, or other platforms where decision-making and transactional options are relevant. These could include, but are not limited to, stock trading platforms, cryptocurrency exchanges, or any other system that involves decision-making processes, real-time event resolutions, and the ability to construct sequences of transactions based on dynamic outcomes. The underlying principles of strategic decision-making, risk management, and dynamic reward structures extend beyond gaming or betting and can be adapted to any context that involves a plurality of binary outcome transactions.

The methods and systems described herein do not rely on random number generation. Instead, they leverage the dynamic and unpredictable nature of real-life events, such as market conditions, financial transactions, or real-time activities, depending on the context in which the system is applied. Participants' decisions are based on their own judgment, analysis, and intuition, rather than on chance or random factors. As such, the methods and systems described herein are distinguished from traditional games of chance or random-based models, as they emphasize the participant's ability to draw on factors such as timing, insights, and their understanding of the relevant real-world conditions to make informed, strategic decisions in response to dynamic, evolving scenarios.

The methods and systems described herein provide a technological solution to technical problems related to user engagement and control by utilizing existing data in novel ways to generate new transaction options and offer the potential for greater rewards. For example, the methods and systems described herein overcome the rigidity of traditional parlay systems by providing an interactive experience that allows a series to evolve dynamically, with new legs being added after the resolution of each leg, encouraging user involvement. This transforms traditional betting, for example, by enabling participants to tailor their experience according to their risk preferences, desired reward levels, and personal strategies. It also significantly expands the range of transaction options available within a single transaction, as additional transaction options become available after the transaction begins, allowing participants to adjust and adapt as the series progresses. Additionally, the methods and systems described herein help mitigate the correlation between binary contracts, even those that are closely related, by adding them sequentially to the series. This approach ensures that the outcome of each preceding transaction option is reflected in the pricing of the subsequent transaction option.

The technical effect of the methods and systems described herein is achieved through the use of a computing system configured to perform one or more of the following operations: (i) determine a first plurality of transaction options associated with a first plurality of events; (ii) receive a request to initiate a transaction on a first event of the first plurality of events; (iii) determine a result of the first transaction option based on a result of the first event; (iv) present an option to either execute a potential payout for the first transaction option or continue the transaction; and (v) determine a second plurality of transaction options associated with a second plurality of events for constructing a series including the first transaction option and a second transaction option of the second plurality of transaction options.

Aspects of the present disclosure provide for a computing system that performs one or more operations in an environment including a plurality of devices coupled to each other via a network (e.g., a local area network (LAN), a wide area network (WAN), the internet). The methods and systems described herein may be implemented using computer programming or engineering techniques, including computer software, firmware, hardware, or a combination or subset thereof. Unless otherwise defined, all technical and scientific terms used herein shall have the same meaning as commonly understood by one of ordinary skill in the art to which the present disclosure belongs. Although any method or system similar or equivalent to those described herein can be used in the practice or testing of the present disclosure, some examples are described below.

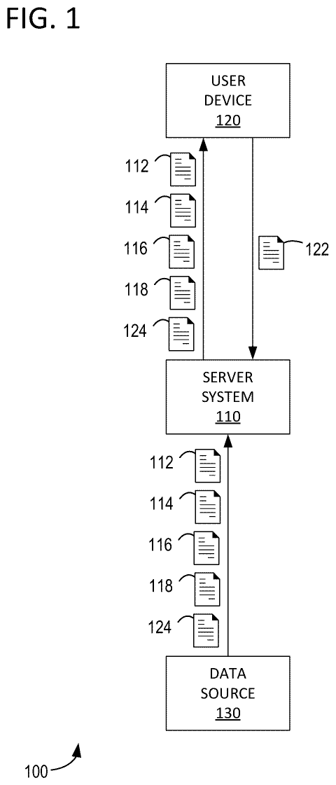

FIG. 1 shows an example system 100 including one or more server systems 110 that manage interactions within the system 100. The server system 110 is configured to determine or identify one or more betting or transaction options 112 and a probability 114 associated with each transaction option 112, enabling participants to engage in transactional activities across a variety of events.

Transaction options 112 represent specific predictions or choices related to one or more events. The transaction options 112 may take various forms depending on the nature of the event, and they allow participants to engage with various aspects of the event, from broad outcomes (e.g., match claimants) to more granular outcomes (e.g., individual participant performance, team statistics). For instance, in the context of sports betting, example transaction options 112 may include: (i) a moneyline bet on the claimant of a game or match; (ii) a point spread bet on whether one team or competitor (the “favorite”) will win a game or match by more than a predicted margin (the “point spread”), or the other team or competitor (the “underdog”) will lose the game or match by less than the point spread or win outright; (iii) an over/under (totals) bet on whether a combined point total of a game or match will be over or under a predicted amount; (iv) a futures bet on the outcome of a longer-term event, such as the claimant of a league championship or tournament; or (v) a proposition or prop bet on the outcome of a specific occurrence within an event, such as whether a particular competitor will score in a game or match. In the context of prediction markets, example transaction options 112 may include binary contracts or options that have two possible outcomes (e.g., yes/no, true/false). In the context of commodities markets, example transaction options 112 may include binary contracts or options that are structured around whether the price of a commodity (e.g., oil, gold, etc.) will be above or below a certain level at a specific time.

The system 100 supports binary outcome transactions, such as predicting the outcome of sports events or forecasting commodity prices. In these types of transactions, the probability 114 represents a likelihood of a corresponding transaction option 112 occurring. The probability 114 may be predefined or implied. The probability 114 may be represented in various formats, such as a percentage (e.g., 25%), fractional (e.g., 5/1), decimal (e.g., 6.00), or moneyline (e.g., +500, −150). The occurrence of a transaction option 112 refers to the realization or actualization of one of two possible outcomes in a situation where only two outcomes are possible. Accordingly, the probability 114 directly affects a potential payout 116 that a participant can receive if their transaction option is successful. Generally, lower probabilities 114 are associated with higher potential payouts 116 reflecting a higher risk due to a lower perceived chance of success, while higher probabilities 114 are associated with lower potential payouts 116 reflecting a lower risk due to a higher perceived chance of success.

In some examples, the server system 110 may update the transaction options 112 and/or probabilities 114 in real-time to reflect changes in underlying conditions and/or market trends. This allows the system 100 to offer a variety of transaction options 112 which may be tailored to participant strategies, preferences, and insights. Real-time updates also ensure that the probabilities 114 remain relevant and fair throughout the duration of the transactional process, adjusting for injuries, participant or team performance, or public transactional behavior.

Additionally or alternatively, the server system 110 may determine or identify a result 118 for each transaction option 112, which reflects a final decision, result, or resolution of the associated event. The result 118 informs the server system 110 of whether a participant's transaction was successful.

As shown in FIG. 1, the server system 110 may be communicatively coupled to one or more user devices 120. In some examples, the server system 110 communicates with the user device 120 to present transaction options 112, probabilities 114, potential payouts 116, and/or results 118 to a participant associated with the user device 120. The server system 110 is configured to manage participant accounts, ensuring that the system 100 operates in accordance with applicable rules and regulations.

To initiate a transaction, the user device 120 may transmit a request to make a transaction, or transaction request 122, to the server system 110. In some examples, the transaction request 122 may include a selection or identification of a transaction option 112. Upon receiving the transaction request 122, the server system 110 determines whether to accept or reject the transaction request 122 based on a number of criteria, such as the participant's account balance, a transaction window for the event or system 100, a range of valid transaction amounts, or a validity of the information for the event or system 100. For example, the transaction request 122 may be rejected for insufficient funds, closed transaction window, invalid transaction amount, or outdated information. If the transaction request 122 is accepted, the server system 110 processes the transaction request 122, tracks the progress of the relevant transaction option 112, and updates the participant account accordingly. If the transaction is successful, i.e., the participant's prediction or choice is correct, the server system 110 then presents an option 124 for the participant to execute the potential payout 116 or continue the transaction.

As shown in FIG. 1, the server system 110 may be communicatively coupled to one or more data sources 130. In some examples, the server system 110 communicates with the data source 130 to receive or retrieve transaction options 112, probabilities 114, potential payouts 116, and results 118. The data source 130 may be or include an external database, a data provider, and/or a third-party service that supplies real-time event data, news feeds, statistics, and/or other information. In some examples, the server system 110 may receive or retrieve data from the same or different data sources 130, depending on the specific needs of the event or market.

Communication between the server system 110, user device 120, and data source 130 may be direct or indirect and may use one or more communication protocols. For example, the server system 110, user device 120, and/or data source 130 may communicate over one or more communication networks, such as the internet or private networks (e.g., (e.g., local area networks and enterprise networks (e.g., LAN, WAN, or enterprise networks), and the communication network may facilitate communication through one or more protocols, such as hypertext transfer protocol (HTTP), HTTP Secure (HTTPS), WebSocket, or other network protocol for secure, real-time data transfer.

The communication network allows the server system 110, user devices 120, and data sources 130 to interact in real-time, providing participants with up-to-date information regarding transaction options 112, probabilities 114, potential payouts 116, and/or results 118. The server system 110, user devices 120, and/or data sources 130 may utilize specialized hardware and/or software to form non-generic, particular machines or apparatuses that comply with regulatory requirements regarding devices used for wagering or games of chance that provide monetary awards.

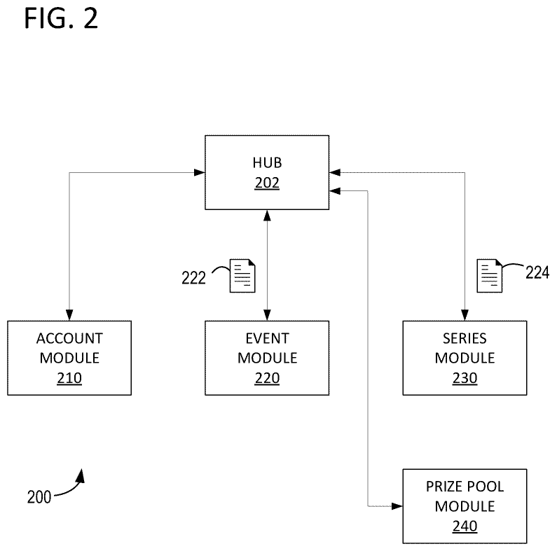

FIG. 2 shows an example server 200 (e.g., server system 110) that may be used to manage various operations within the system 100 (shown in FIG. 1). As shown in FIG. 2, the server 200 may include a hub 202 configured to facilitate seamless user interactions and efficient data processing. For example, the hub 202 may receive, process, and distribute requests from users and/or other system modules, including an account module 210, an event module 220, and a series module 230.

The account module 210 is configured to manage participant accounts, ensuring accurate tracking of balances, transaction histories, and personalized preferences. The account module 210 processes user input related to account queries and facilitates transactions such as deposits, withdrawals, and transaction settlements. The account module 210 ensures account-related operations are executed securely, efficiently, and in compliance with regulatory requirements, such as age verification and geographical restrictions.

The event module 220 is configured to manage event-specific data, including transaction options 112, probabilities 114, and results 118. This includes aggregating data from external sources (e.g., data sources 130) to ensure that the transaction options 112, probabilities 114, and results 118 are accurate and up-to-date for each event. In some examples, the event module 220 may determine and/or adjust probabilities 114 based on factors like market demand, participant activity, and/or external data (e.g., injuries, weather conditions). The event module 220 dynamically updates transaction options 112, probabilities 114, and results 118 in real-time, ensuring that real-time scenarios are supported effectively.

The event module 220 processes user inputs, such as transaction requests 122, and tracks the progress of the relevant transaction option 112 throughout the event. A transaction request 122 may include a selection or identification of a transaction option 112 and an initial stake 222 committed to the transaction option 112. The initial stake 222, along with the probabilities 114, determines how much the participant can gain or lose from the transaction. After the conclusion of an event, the event module 220 updates the outcome (e.g., whether the participant's prediction or choice is correct). If the participant's prediction or choice is incorrect, the participant forfeits the initial stake 222. Conversely, if the participant's prediction or choice is correct, the event module 220 presents the participant with an option to either collect the potential payout 116 or continue the transaction. If the participant chooses to collect the potential payout 116, the event module 220 communicates with the account module 210 to execute payment of the potential payout 116 (including the initial stake 222). If the participant chooses to continue the transaction, the event module 220 communicates with the series module 230 to extend the series, which is described in more detail below. In some examples, the event module 220 may process data related to participant behavior, system performance, and/or market trends to generate one or more insights or recommendations for use in determining one or more transaction options 112 and/or probabilities 114 and/or enhancing system functionality.

The series module 230 is configured to manage the structure and execution of a series including two or more bets or “legs”. The success of a series depends on the outcome of each leg: if any leg results in a loss, the entire series is considered lost or unsuccessful; if all legs are successful, the series is successful. The series module 230 tracks the initial stake 222, determines cumulative probability 224, and determines potential payouts 116 for each leg of the series. In some examples, the series module 230 may communicate with the event module 220 to receive or retrieve event-specific data (e.g., probabilities 114), and recalculate cumulative probability 224 each time a new leg is added, ensuring that the potential payout 116 is accurate and based on the updated cumulative probability 224. As each new leg is added, participants can compound their previous decisions and maximize their potential returns.

The series module 230 supports flexible series functionality, allowing participants to add additional legs after each leg is resolved and adjusting the cumulative probability 224 and potential payout 116 as described above. This ensures that the outcome of each preceding leg is reflected in the pricing of the subsequent leg. In some examples, the series module 230 may automatically terminate a series based on predefined criteria, such as when a certain profit threshold or cumulative probability threshold is reached. The series module 230 may include risk management features, like adjusting the vigorish (vig) or offering an auto-payout option for participants to secure their payouts when they reach a desired threshold in the series.

By enabling participants to add an additional leg to an ongoing series, the series module 230 allows for ongoing, real-time participant engagement and decision-making, where the range of transaction options 112 available with each leg stay fresh, allowing participants to adjust and adapt as the series progresses. Moreover, in some examples, participants' transactional decisions may be dynamically influenced by real-time event-driven data, such as the outcomes of live events or fluctuations in market conditions. This allows for ongoing, real-time participant engagement and decision-making, with each successive leg informed by the resolution of previous legs, empowering participants to make informed, adaptive decisions. This real-time adaptability is key to ensuring continuous engagement and can be applied across a wide range of industries, including gaming, financial markets, event forecasting, or e-commerce platforms where real-time data influences decision-making

By allowing participants to add additional legs to an ongoing series, the series module 230 facilitates continuous, real-time engagement and decision-making. The range of transaction options 112 available with each leg remains dynamic, enabling participants to adjust and adapt as the series progresses. This adaptability ensures that each successive leg is informed by the resolution of prior legs, empowering participants to make strategic, informed choices. In some examples, participants' decisions may be influenced by real-time, event-driven data, such as live event outcomes or market fluctuations.

In some examples, the server 200 may include a prize pool module 240 configured to manage a prize pool. For example, the prize pool module 240 may handle various aspects of a prize pool system, including prize pool calculations, eligibility criteria, and distribution of prize pool payouts. The prize pool module 240 enhances participant engagement by offering an opportunity to unlock additional returns based on strategic transactional choices. The prize pool system may operate in different contexts: for example, in the context of a series of bets that are linked in a single parlay-like transaction (e.g., when coupled with the dynamic transaction system) or in the context of sequential, otherwise individual wagers that are considered collectively for prize pool purposes (e.g., when the prize pool system operates free from the dynamic transaction system, with no intervening loss or prize pool distribution between the wagers). By integrating the prize pool system with the dynamic transaction system, participants are further incentivized to engage in higher-risk, higher-reward bets. Alternatively, the prize pool system may be configured to function independently of the dynamic transaction system.

The prize pool module 240 grows and maintains the prize pool through systematic contribution mechanisms. The prize pool module 240 may track allocations to the prize pool, including contributions from various transactions. In some examples, the prize pool module 240 allocates a predefined portion or percentage from each unsuccessful transaction to the prize pool. Additionally or alternatively, the prize pool module 240 may allocate a predefined portion or percentage of each transaction at the time it is initiated. In the event that the prize pool falls below a certain threshold (e.g., after a prize pool payout), the prize pool module 240 may automatically reseed or replenish it to restore the balance to at least the threshold amount, ensuring continued viability.

The prize pool module 240 may implement a multi-tiered progressive prize pool payout structure, where each tier is associated with specific eligibility criteria based on various transactional parameters. Such eligibility criteria may include, but are not limited to, the stake amount, the number of successful legs, and/or the cumulative probability achieved. Table 1 shows an example prize pool system with tiered prize pool payouts. In some examples, the prize pool module 240 may monitor transactional activity against the eligibility criteria for each tier. For example, the prize pool module 240 may track the stakes, validate qualifying legs, and/or calculate cumulative probabilities 224 in real-time to determine tier qualification.

TABLE 1

| | | # OF | | % OF |
|---|---|---|---|---|
| | STAKE | QUALIFYING | CUMULATIVE | PRIZE |
| TIER | AMOUNT | LEGS | PROB. (MAX) | POOL |
| 1 | $5 | 4 | 1.96% | 0.5% |
| 2 | $10 | 4 | 0.9% | 1.0% |
| 3 | $10 | 4 | 0.3% | 2.5% |
| 4 | $10 | 3 | 0.1% | 5.0% |
| 5 | $25 | 3 | 0.1% | 7.5% |
| 6 | $50 | 4 | 0.1% | 10.0% |
| 7 | $50 | 6 | 0.1% | 12.5% |
| 8 | $100 | 8 | 0.02% | 50.0% |

When a participant meets the eligibility criteria for a particular tier, the prize pool module 240 may determine a potential prize pool payout based on a size of the prize pool and a predefined percentage of the prize pool associated with that tier. Generally, lower tiers featuring more accessible thresholds, such as smaller stakes, fewer successful legs, and/or higher cumulative probabilities 224, are associated with smaller percentages, while higher tiers featuring more demanding thresholds, such as larger stakes, more successful legs, and/or lower cumulative probabilities 224, are associated with larger percentages. However, these relationships may be tailored, with certain factors adjusted to incentivize specific participant behaviors and/or align with broader goals, such as increasing engagement, transaction volume, or revenue. For example, one or more factors may be adjusted to encourage higher stakes, longer streaks, and/or more aggressive strategies.

For example, based on the eligibility criteria outlined in Table 1, a participant with a stake amount of $5 who completes 4 qualifying legs (e.g., some legs may not count if other conditions are not met) and achieves a cumulative probability of 2.5% would not be eligible for a prize pool payout because the cumulative probability of 2.5% is too high; however, they could be incentivized to place another bet to decrease the cumulative probability to 1.96% or less, thereby qualifying for Tier 1 which offers a 0.5% prize pool payout, although they would be capped at that payout level due to their stake amount being insufficient to qualify for any other tier. Another participant with a stake amount of $10 who completes 3 qualifying legs and achieves a cumulative probability of 0.4% would qualify for Tier 2, which offers a 1.0% prize pool payout; they could be incentivized to place another bet to decrease the cumulative probability to 0.3% or less, thereby qualifying for Tier 3, which offers a 2.5% prize pool payout, or even to 0.1% or lower, qualifying them for Tier 4, which offers a 5.0% prize pool payout.

In some examples, the prize pool module 240 may determine at least one recommended or suggested transaction option 112 based on one or more transactional parameters, such as probabilities 114, potential payouts 116, cumulative probabilities 224, stake amount, number of legs, and/or potential prize pool payout. Additionally, the prize pool module 240 may determine a projected tier (e.g., associated with a potential transaction option 112) and a size of the prize pool to determine a potential prize pool payout. In some examples, the potential prize pool payout may be determined as of the time the final qualifying leg is graded.

The prize pool module 240 may provide various payout mechanisms. For example, if a participant meets the specific eligibility criteria for a prize pool payout and has successfully completed all outstanding legs, the prize pool module 240 may present the participant with an option to collect the prize pool payout. In some examples, the prize pool module 240 may determine the prize pool payout based on the tier achieved, stake amount, number of successful legs, cumulative probability achieved, time of transaction, and/or other desired factors. If the participant chooses to collect the prize pool payout, the prize pool module 240 communicates with the account module 210 to execute the payment. Alternatively, the prize pool module 240 may be configured to automatically execute the prize pool payout when the participant reaches a predefined tier level or other threshold. For example, the prize pool payout may be automatically executed when the participant reaches the maximum tear, maximum payout, or another parameter defined by the system or participant.

In some examples (e.g., where the prize pool system is integrated with the dynamic transaction system), the prize pool payout may be distributed with the potential payout 116 when either is chosen to be collected. In other examples (e.g., where the prize pool system operates free from the dynamic transaction system), the prize pool module 240 may track the stakes, transactions, payouts, and/or other transactional parameters independent of the dynamic transaction system such that the prize pool payout may be distributed independent of the potential payout 116 as the specific eligibility criteria are achieved. In this case, the participant may choose to execute the prize pool payout without collecting a potential payout 116, or vice versa.

To maintain transparency and inform participant decision-making, the prize pool module 240 may continuously update the current prize pool balance to reflect new allocations, distributions, and potential prize pool payouts. This real-time information helps participants evaluate strategic betting opportunities and track their progress toward higher reward tiers. In scenarios with multiple qualified claimants, the prize pool module 240 may handle the distribution based on predefined distribution rules based on the tier achieved, stake amount, number of successful legs, cumulative probability achieved, time of transaction, and/or other desired factors.

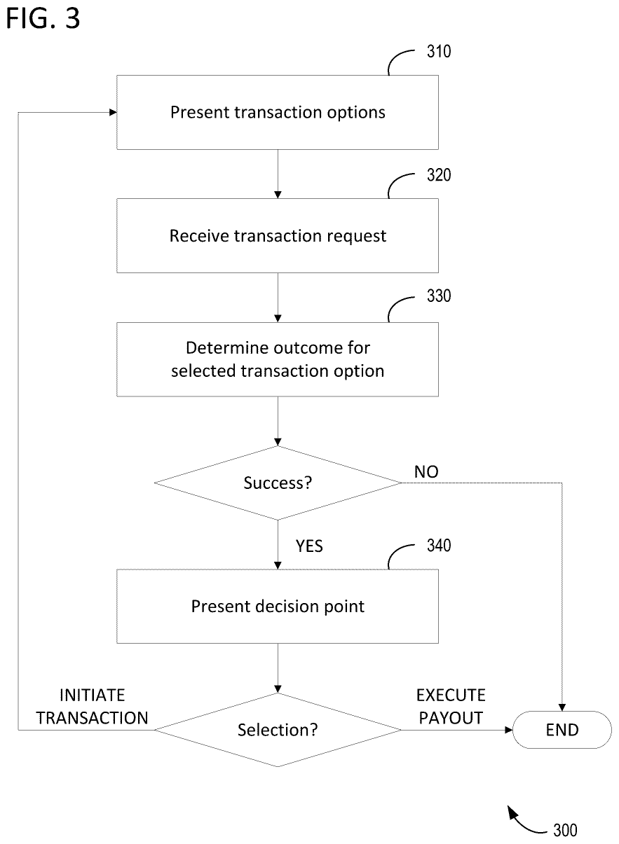

FIG. 3 shows an example method 300 for providing a dynamic transaction system. The method 300 may be implemented by the system 100 (shown in FIG. 1) and/or the server 200 (shown in FIG. 2). In some examples, a first plurality of transaction options 112 associated with a first plurality of events are presented at operation 310. Each transaction option 112 represents an individual outcome that can be selected by a participant. A request to make a transaction on a first event of the first plurality of events (e.g., first transaction request 122) is received at operation 320. The first transaction request 122 is associated with a first transaction option 112 of the first plurality of transaction options 112.

In some examples, the first transaction request 122 includes a selection or identification of the first transaction option 112 and an initial stake 222 committed to the first transaction option 112. If the first transaction request 122 is rejected, then there is no transaction and another plurality of events may be presented (e.g., at operation 310). On the other hand, if the first transaction request 122 is accepted, the first event is tracked to facilitate determining a result 118 for the first transaction option 112.

The result 118 for the first transaction option 112 is determined or identified at operation 330. In some examples, the result 118 is determined based on a result of the first event. If the result 118 of the first transaction option 112 is unsuccessful (e.g., the participant's prediction or choice is incorrect), then the transaction is considered lost or unsuccessful and the method 300 ends. On the other hand, if the result 118 of the first transaction option 112 is successful (e.g., the participant's prediction or choice is correct), a decision point is presented at operation 340 with an option 124 to either execute a potential payout 116 or continue the transaction.

In some examples, the potential payout 116 may be determined based on the initial stake 222 committed to the transaction option 112 and the probabilities 114 associated with the transaction option 112. If the participant chooses to execute the potential payout 116, a payment is made and the method 300 ends. On the other hand, if the participant chooses to continue the transaction, the method 300 returns to operation 310, where a second plurality of transaction options 112 associated with a second plurality of events is presented. In some examples, the second plurality of events are different from the first plurality of events. For example, the second plurality of transaction options 112 may include at least one new transaction option 112 that was not included in the first plurality of transaction options 112. The second plurality of transaction options 112 are presented for a second leg of a series which will include both the first transaction option 112 and a second transaction option 112 that is selected or identified from the second plurality of transaction options 112. In some examples, the cumulative probability 224 for the series are recalculated based on transaction probabilities 114 (e.g., the probabilities 114 of both the first transaction option 112 and the second transaction option 112). This cycle repeats until either the series is lost (e.g., the outcome of a selected transaction option is unsuccessful) or the potential payout 116 is executed.

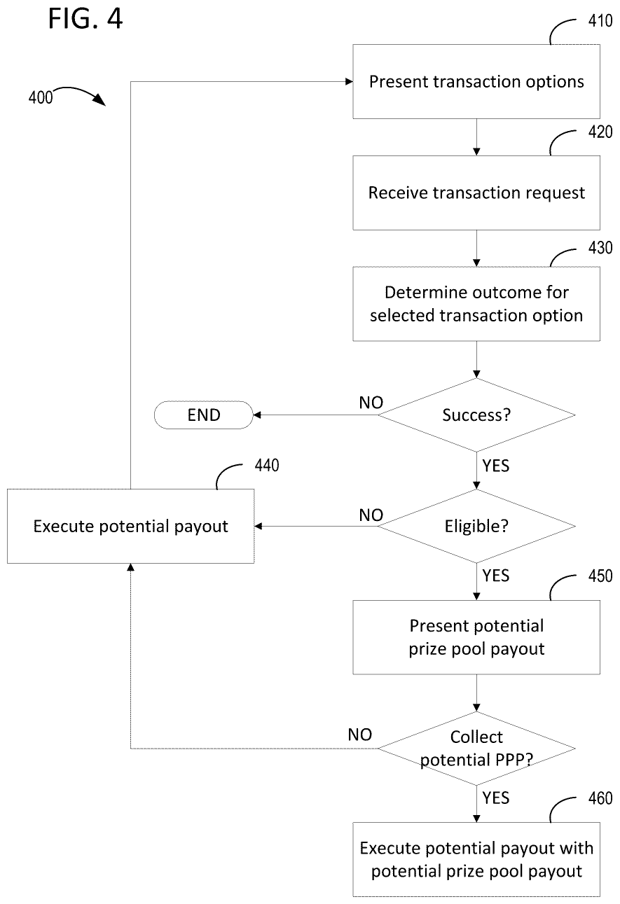

FIG. 4 shows an example method 400 for providing a prize pool system. The method 400 may be implemented by the system 100 (shown in FIG. 1) and/or the server 200 (shown in FIG. 2). In some examples, a first plurality of transaction options 112 associated with a first plurality of events are presented at operation 410. Each transaction option 112 represents an individual outcome that can be selected by a participant. A request to make a transaction on a first event of the first plurality of events (e.g., first transaction request 122) is received at operation 420. The first transaction request 122 is associated with a first transaction option 112 of the first plurality of transaction options 112.

In some examples, the first transaction request 122 includes a selection or identification of the first transaction option 112 and a first stake committed to the first transaction option 112. If the first transaction request 122 is rejected, then there is no transaction and another plurality of events may be presented (e.g., at operation 410). On the other hand, if the first transaction request 122 is accepted, the first event is tracked to facilitate determining a result 118 for the first transaction option 112.

The result 118 for the first transaction option 112 is determined or identified at operation 430. In some examples, the result 118 is determined based on a result of the first event. If the result 118 of the first transaction option 112 is unsuccessful (e.g., the participant's prediction or choice is incorrect), then the transaction is considered lost or unsuccessful and the method 400 ends. On the other hand, if the result 118 of the first transaction option 112 is successful (e.g., the participant's prediction or choice is correct), it is determined whether the participant satisfies or meets predefined eligibility criteria for a prize pool payout. In some examples, eligibility may be determined by calculating the cumulative probability 224 of the transaction options 112 in the current streak of successful transaction options 112, where the streak is measured starting after the participant's most recent unsuccessful transaction option 112 and the participant's most recent prize pool payout. If the participant does not satisfy or meet the predefined eligibility criteria for a prize pool payout, the potential payout 116 is executed at operation 440 and the method 400 returns to operation 410, where a second plurality of transaction options 112 associated with a second plurality of events is presented. On the other hand, if the participant satisfies or meets the predefined eligibility criteria for a prize pool payout, a potential prize pool payout is presented at operation 450. In some examples, the potential prize pool payout may be determined based on a predefined percentage of the prize pool. If the participant chooses to collect the potential prize pool payout, the potential payout 116 is executed at operation 460 with the potential prize pool payout. On the other hand, if the participant chooses not to collect the potential prize pool payout, the potential payout 116 is executed at operation 440 and the method 400 returns to operation 410, where a second plurality of transaction options 112 associated with a second plurality of events is presented.

In some examples, the second plurality of events are different from the first plurality of events. For example, the second plurality of transaction options 112 may include at least one new transaction option 112 that was not included in the first plurality of transaction options 112. The second plurality of transaction options 112 are presented for a second transaction of a sequence or prize pool series which will include both the first transaction option 112 and a second transaction option 112 that is selected or identified from the second plurality of transaction options 112. In some examples, each transaction option 112 included in the prize pool series is tracked solely for prize pool-related purposes (e.g., for determining eligibility for a prize pool payout). This cycle repeats until either the prize pool series is lost (e.g., the outcome of a selected transaction option is unsuccessful) or the potential prize pool payout is executed (e.g., at operation 460).

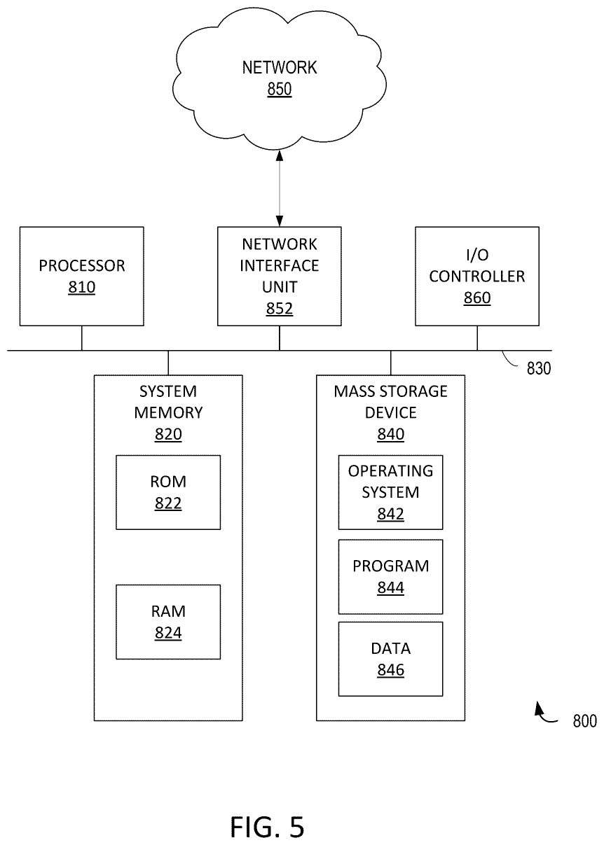

FIG. 5 shows an example computing system 800 (e.g., system 100, server system 110, user device 120, data source 130, server 200, hub 202, account module 210, event module 220, series module 230) configured to perform one or more computing operations described herein. In some examples, the computing system 800 includes a processor 810, a system memory 820, and a bus 830 coupling various system components including the system memory 820 to the processor 810.

The processor 810 is configured to perform general computing functions and process data and instructions to perform one or more operations and/or provide other functionality described herein. For example, the processor 810 may access the system memory 820 to read data and instructions from and/or write data and instructions to the system memory 820 for use in executing one or more computer-executable instructions. In this manner, the processor 810 may be programmed to execute any aspect of the software components described herein, including software components for executing, implementing, and/or employing the system 100 (shown in FIG. 1), server system 110 (shown in FIG. 1), user device 120 (shown in FIG. 1), data source 130 (shown in FIG. 1), server 200 (shown in FIG. 2), hub 202 (shown in FIG. 2), account module 210 (shown in FIG. 2), event module 220 (shown in FIG. 2), series module 230 (shown in FIG. 2), prize pool module 240 (shown in FIG. 2), method 300 (shown in FIG. 3), method 400 (shown in FIG. 4), and/or method 500 (shown in FIG. 5). In some examples, the processor 810 may be or include any quantity of processing units including a central processing unit, a graphics processing unit, a field-programmable gate array (FPGA), a digital signal processor (DSP), or other hardware logic components including, without limitation, an Application-Specific Integrated Circuit (ASIC), Application-Specific Standard Product (ASSP), System-on-a-Chip System (SOC), Complex Programmable Logic Device (CPLD), etc.

The system memory 820 includes any combination of computer-readable media that may be accessed by the processor 810. In some examples, the system memory 820 includes a read-only memory (ROM) 822 which stores instructions for executing basic functions and a random access memory (RAM) 824 which temporarily stores data and instructions for actively used programs. For example, the RAM 824 may be used to host or store user data, device data, system data, and the like, as well as one or more software components for executing, implementing, and/or employing the system 100 (shown in FIG. 1), server system 110 (shown in FIG. 1), user device 120 (shown in FIG. 1), data source 130 (shown in FIG. 1), server 200 (shown in FIG. 2), hub 202 (shown in FIG. 2), account module 210 (shown in FIG. 2), event module 220 (shown in FIG. 2), series module 230 (shown in FIG. 2), prize pool module 240 (shown in FIG. 2), method 300 (shown in FIG. 3), method 400 (shown in FIG. 4), and/or method 500 (shown in FIG. 5).

Computer-readable media includes both communication media and computer storage media. Communication media typically embody computer-readable instructions, data structures, program modules, or other data in a modulated data signal, such as a carrier wave or other transport mechanism. The term “modulated data signal” means a signal that has one or more of its characteristics set or changed in a manner as to encode information in the signal. By way of example, and not limitation, communication media includes wired media, such as a wired network or direct-wired connection, and wireless media, such as acoustic, radio frequency, and infrared media.

In contrast, computer storage media include tangible forms of media that can store information such as computer-readable instructions, data structures, program modules, or other data. By way of example, and not limitation, computer storage media includes ROM 822, RAM 824, hard disk drives (HDDs), solid-state drives (SSDs), external hard drives, flash drives, optical storage media (e.g., compact discs (CDs), digital versatile discs (DVDs), and magnetic storage media (e.g., tape drives). For purposes of the present disclosure, computer storage media is mutually exclusive to communication media and excludes waves, signals, and other transitory or intangible forms of media.

It should be appreciated that the software components described herein, when loaded into the processor 810 and executed, may transform the processor 810 and the overall computing system 800 from a general-purpose computing system into a special-purpose computing system customized to facilitate the functionality described herein. More specifically, the computer-executable instructions contained within the software components described herein transform the processor 810 to operate or function as a finite-state machine by specifying how the processor 810 transitions between states, thereby transforming the transistors or other discrete circuit elements constituting the processor 810.

Encoding the software components described herein may also transform the physical structure of the computer-readable media described herein. The specific transformation of physical structure may depend on various factors, in different implementations of the present disclosure. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the transistors, capacitors, or other discrete circuit elements constituting the semiconductor-based memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In some examples, the computing system 800 includes a mass storage device 840 coupled to the processor 810 for hosting or storing data and instructions, such as an operating system 842, one or more programs 844, and/or data 846. One of ordinary skill in the art would understand that copies of at least some data and/or instructions hosted or stored in the mass storage device 840 may be at least temporarily stored in the system memory 820 to enable the computing system 800 to function as described herein.

As shown in FIG. 5, the computing system 800 may connect to a network 850 through a network interface unit 852 connected to the bus 830. In this manner, the computing system 800 may operate in a networked environment in which the computing system 800 may use one or more remote devices to host or store at least some data and/or to execute at least some instructions. Computer communication between computing systems can be a network transfer, a file transfer, an applet transfer, an email, a HTTP transfer, and so on.

In some examples, the computing system 800 may include one or more input/output (I/O) controllers 860 that facilitate communication and data transfer between the processor 810 and one or more I/O devices (not shown) configured to provide input and/or output capabilities. For example, a user may enter commands and information into the computing system 800 using one or more input devices, such as a keyboard, pointing device (e.g., mouse, trackball, touch pad, stylus), microphone, camera, scanner, accelerometer, and the like. Additionally or alternatively, the computing system 800 may present various forms of information, such as text, images, audio, video, alerts, and the like, using one or more output devices, such as a monitor, projector, printer, speaker, actuator, and the like. In some examples, the output device may be integrated with the input device (e.g., in a touchscreen panel or in a controller including a vibrating component).

While some examples are illustrated and described herein with reference to the computing system 800 being, including, or being included in the system 100 (shown in FIG. 1), server system 110 (shown in FIG. 1), user device 120 (shown in FIG. 1), data source 130 (shown in FIG. 1), server 200 (shown in FIG. 2), hub 202 (shown in FIG. 2), account module 210 (shown in FIG. 2), event module 220 (shown in FIG. 2), series module 230 (shown in FIG. 2), and/or prize pool module 240 (shown in FIG. 2), aspects of the present disclosure are operable with any computing system that can execute computer-executable instructions to implement the operations and functionality associated with the computing system 800. It is also contemplated that the computing system 800 may not include all of the components shown in FIG. 5, may include other components that are not explicitly shown in FIG. 5, or may utilize an architecture completely different than that shown in FIG. 5. The computing system 800 should not be interpreted as having any dependency or requirement relating to any one or combination of components shown in FIG. 5. The computing system 800 is only one example of a computing and networking environment for performing one or more computing operations and is not intended to suggest any limitation as to the scope of use or functionality of the present disclosure.

Example methods and systems are described herein for providing an enhanced transactional platform that promotes participant engagement and retention. This is achieved by offering participants the opportunity to capitalize on real-time events, leveraging both participant intuition and strategic decision-making. Participants are empowered with the option to either collect a potential payout or continue engaging in a series of bets that are linked in a single parlay-like transaction. This flexibility adds a layer of excitement and challenge, encouraging continued participation. Engagement and retention may also be promoted by offering opportunities to unlock prize pool payouts based on strategic transactional choices. The prize pool system may be configured to encourage or incentivize specific participant behaviors, such as placing frequent wagers, pursuing longer streaks, and/or adopting more aggressive betting strategies.

The examples described herein are broadly applicable to a wide range of transactional environments, including but not limited to, sports betting, financial markets, prediction markets, and other exchange-based or decision-making platforms. These types of environments rely on a series or sequence of transaction options, where each decision may compound based on prior actions or events. Accordingly, the examples provided herein offer a dynamic, interactive solution for platforms seeking to increase user engagement and provide a more skill-based decision-making experience in which participants' decisions are based on their own judgment, analysis, and intuition, rather than on chance or random factors. In view of the above, it will be seen that several advantages of the aspects of the present disclosure are achieved and other advantageous results attained.

In view of the above, several advantages of the present disclosure are achieved, including but not limited to greater participant involvement and retention and the ability to offer varied risk-reward scenarios that cater to both casual and more strategic participants. Additionally, the system provides the flexibility to scale across different industries where predictive, probabilistic decision-making is central to the user experience, resulting in more rewarding and engaging interactions for users across various types of transactional systems.

Although described in connection with an example transaction system, examples of the present disclosure are capable of implementation with numerous other general purpose or special purpose computing system environments, configurations, or devices. Examples of well-known computing systems, environments, and/or configurations that may be suitable for use with aspects of the disclosure include, but are not limited to, server computers, desktop computers, laptop computers, tablets, mobile devices, communication devices in wearable or accessory form factors, microprocessor-based systems, multiprocessor systems, programmable consumer electronics, kiosks, tabletop devices, industrial control devices, minicomputers, mainframe computers, network computers, distributed computing environments that include any of the above systems or devices, and the like.

Examples of the present disclosure may be described in the general context of computer-executable instructions, such as program modules (e.g., account module 210, event module 220, series module 230, prize pool module 240), executed by one or more computers or other devices in software, firmware, hardware, or a combination thereof. The computer-executable instructions may be organized into one or more computer-executable modules or components. Generally, program modules include, but are not limited to, routines, objects, components, and data structures that perform particular tasks or implement particular abstract data types. Aspects of the disclosure may be implemented with any number and organization of such modules or components. For example, aspects of the present disclosure are not limited to the specific computer-executable instructions or the specific components or modules illustrated in the figures and described herein. Other examples of the present disclosure may include different computer-executable instructions or components having more or less functionality than illustrated and described herein.

In some examples, the operations illustrated in the drawings may be implemented as software instructions encoded on a computer readable medium, in hardware programmed or designed to perform the operations, or both. For example, aspects of the present disclosure may be implemented as a system on a chip or other circuitry including a plurality of interconnected, electrically conductive elements.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

The order of execution or performance of the operations in examples of the present disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the present disclosure.

The examples illustrated and described herein as well as examples not specifically described herein but within the scope of aspects of the present disclosure constitute example means for providing a dynamic transaction system. For example, the elements illustrated in FIGS. 1, 2, and 5, when programmed, encoded, or configured to perform the operations illustrated in FIGS. 3 and 4, constitute at least an example means for determining a plurality of transaction options associated with a plurality of events (e.g., server system 110, data source 130, event module 220), presenting a plurality of transaction options associated with a plurality of events (e.g., user device 120, event module 220), receiving a request to initiate a transaction on an event (e.g., server system 110, user device 120, hub 202, event module 220), determining an outcome for a transaction option based on a result of an event (e.g., server system 110, data source 130, event module 220), and/or presenting an option to either execute a potential payout or continue the transaction (e.g., user device 120).

When introducing elements of aspects of the disclosure or the examples thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

In the present description, reference numbers have sometimes been used in connection with various terms. Where a term is used in connection with a reference number, this may be meant to refer to a specific element that is shown in one or more of the figures. Where a term is used without a reference number, this may be meant to refer generally to the term without limitation to any particular figure.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the aspects of the present disclosure have been described in terms of various examples with their associated operations, a person skilled in the art would appreciate that a combination of operations from any number of different examples is also within the scope of the aspects of the present disclosure.

The present disclosure also includes any combination of the following clauses:
1. A transactional server 200 configured to: a) communicate with a user device 120 to present a plurality of transaction options 112 associated with a plurality of events to a participant associated with the user device 120; b) receive a transaction request 222 from the user device 120, the transaction request including a selection of one of the plurality of transaction options 112, the selection associated with a selected event of the plurality of events; c) determine a result of the selection based on a result of the selected event; d) on condition that the result of the selection is successful, determine whether the participant is eligible for a prize pool payout; e) on condition that the participant is not eligible for the prize pool payout, repeat operations (a) through (d) using a new plurality of transaction options 112 associated with a new plurality of events with each repetition until the participant is eligible for the prize pool payout; f) upon determining that the participant is eligible for the prize pool payout, communicate with the user device 120 to present a potential prize pool payout to the participant associated with the user device 120; g) on condition that the participant chooses not to collect the potential prize pool payout, repeat operations of (a) through (f) using a new plurality of transaction options 112 associated with a new plurality of events with each repetition until the participant chooses to collect the potential prize pool payout; and h) upon determining that the participant chooses to collect the potential prize pool payout, execute the potential prize pool payout.
2. The transactional server of clause 1, further configured to contribute a predefined portion of each stake 222 to a prize pool, wherein each selection is associated with a respective stake.
3. The transactional server of clause 1 or 2, further configured to determine a probability 114 or 224 associated with each selection.
4. The transactional server of clause 1 or 2, further configured to determine a transaction probability 114 and a cumulative probability 224 associated with the selection.
5. The transactional server of clause 1 or 2, further configured to determine a transaction probability 114 and a cumulative probability 224 associated with each of the plurality of transaction options 112.
6. The transactional server of clause 5, further configured to use the cumulative probability 224 associated with the selection to determine whether the participant is eligible for the prize pool payout.
7. The transactional server of clause 5 or 6, further configured to use the cumulative probability 224 associated with the selection to determine the potential prize pool payout.
8. The transactional server of clause 7, further configured to: determine a size of a prize pool; and determine a percentage of the prize pool, wherein the potential prize pool payout is determined based on the size of the prize pool and the percentage of the prize pool.
9. The transactional server of clause 8, further configured to determine the percentage of the prize pool based on one or more of a stake amount, a number of successful legs, or the cumulative probability 224, wherein the number of successful legs corresponds to a quantity of selections based on the selection from each repetition of operation (b).
10. The transactional server of any of clauses 4-9, further configured to determine the cumulative probability 224 associated with the selection based on the selection from each repetition of operation (b).
11. The transactional server of any of clauses 1-10, further configured to determine whether the participant is eligible for the prize pool payout based on one or more predefined eligibility criteria.
12. The transactional server of any of clauses 1-11, further configured to communicate with the user device to present at least one suggested transaction option 112 of the plurality of transaction options to the participant associated with the user device 120.
13. A computer-implemented method 400 comprising: a) presenting a plurality of transaction options 112 associated with a plurality of events to a participant associated with a user device 120; b) receiving a transaction request 222 including a selection of one of the plurality of transaction options 112, the selection associated with a selected event of the plurality of events; c) determining a result of the selection based on a result of the selected event; d) on condition that the result of the selection is successful, determining whether the participant is eligible for a prize pool payout; e) on condition that the participant is not eligible for the prize pool payout, repeating operations (a) through (d) using a new plurality of transaction options associated with a new plurality of events with each repetition until the participant is eligible for the prize pool payout; f) upon determining that the participant is eligible for the prize pool payout, presenting a potential prize pool payout to the participant associated with the user device 120; g) on condition that the participant chooses not to collect the potential prize pool payout, repeating operations of (a) through (f) using a new plurality of transaction options associated with a new plurality of events with each repetition until the participant chooses to collect the potential prize pool payout; and g) upon determining that the participant chooses to collect the potential prize pool payout, executing the potential prize pool payout.
14. The computer-implemented method of clause 13, further comprising: determining a cumulative probability 224 based on the selection from each repetition of operation (b); and using the cumulative probability 224 to determine whether the participant is eligible for the prize pool payout.
15. The computer-implemented method of clause 13 or 14, further comprising: determining a size of a prize pool; determining a percentage of the prize pool; and determining the potential prize pool payout based on the size of the prize pool and the percentage of the prize pool.

What is claimed is:

1. A computer implemented method comprising:
presenting a first plurality of transaction options associated with a first plurality of events;
receiving a request to initiate a transaction on a first event of the first plurality of events, the request associated with a first transaction option of the first plurality of transaction options;
determining a result of the first transaction option based on a result of the first event;
on condition that the result of the first transaction option is successful, presenting an option to either execute a potential payout for the first transaction option or continue the transaction; and
on condition that continuing the transaction is selected, presenting a second plurality of transaction options associated with a second plurality of events for constructing a series including the first transaction option and a second transaction option of the second plurality of transaction options.

2. The method of claim 1, further comprising contributing a predefined portion of an initial stake to a progressive prize pool, wherein the initial stake is included in the request to initiate the transaction on the first event.

3. The method of claim 1, further comprising determining a probability associated with each of the second plurality of transaction options.

4. The method of claim 1, further comprising determining a transaction probability associated with the second transaction option and a cumulative probability associated with the first transaction option and the second transaction option.

5. The method of claim 1, further comprising determining a transaction probability associated with each of the second plurality of transaction options and a cumulative probability associated with each combination of the first transaction option with each of the second plurality of transaction options.

6. The method of claim 5, further comprising using the cumulative probability to determine a potential prize pool payout associated with each of the second plurality of transaction options.

7. The method of claim 6, further comprising determining at least one suggested transaction option from the second plurality of transaction options based on one or more of the transaction probability, the cumulative probability, or the potential prize pool payout associated with each of the second plurality of transaction options.

8. The method of claim 6, wherein determining the potential prize pool payout comprises:
determining a size of a progressive prize pool; and
determining a projected tier associated with each combination of the first transaction option with each of the second plurality of transaction options, wherein the potential prize pool payout is determined based on one or more of the size of the progressive prize pool and the projected tier.

9. A system for providing a dynamic transaction system, the system comprising:
a user device; and
a server system configured to:
communicate with the user device to present, to a participant associated with the user device, a first plurality of transaction options associated with a first plurality of events;
receive, from the user device, a request to initiate a transaction on a first event of the first plurality of events, the request associated with a first transaction option of the first plurality of transaction options;
determine a result of the first transaction option based on a result of the first event;
on condition that the result of the first transaction option is successful, communicate with the user device to present, to the participant associated with the user device, an option to either execute a potential payout for the first transaction option or continue the transaction; and
on condition that continuing the transaction is selected, communicate with the user device to present, to the participant associated with the user device, a second plurality of transaction options associated with a second plurality of events for constructing a series including the first transaction option and a second transaction option of the second plurality of transaction options.

10. The system of claim 9, wherein the server system is configured to contribute a predefined portion of an initial stake to a progressive prize pool, wherein the initial stake is included in the request to initiate the transaction on the first event.

11. The system of claim 9, wherein the server system is configured to determine a probability associated with each of the second plurality of transaction options.

12. The system of claim 9, wherein the server system is configured to determine a transaction probability associated with the second transaction option and a cumulative probability associated with the first transaction option and the second transaction option.

13. The system of claim 12, wherein the server system is configured to use the cumulative probability to determine a potential prize pool payout associated with the second transaction option.

14. The system of claim 13, wherein the server system is configured to:
determine a size of a progressive prize pool; and
determine a projected tier associated with the second transaction option, wherein the potential prize pool payout is determined based on one or more of the size of the progressive prize pool and the projected tier.

15. The system of claim 9, further comprising a data source, wherein the server system is configured to receive one or more of the first plurality of transaction options, the result of the first transaction option, or the second plurality of transaction options from the data source.

16. A computing system for providing a dynamic transaction system, the computing system comprising:
a processor; and
a computer-readable memory comprising one or more instructions for causing the processor to:
determine a first plurality of transaction options associated with a first plurality of events;
receive a request to initiate a transaction on a first event of the first plurality of events, the request associated with a first transaction option of the first plurality of transaction options;
determine a result of the first transaction option based on a result of the first event;
on condition that the result of the first transaction option is successful, present an option to either execute a potential payout for the first transaction option or continue the transaction; and
on condition that continuing the transaction is selected, determine a second plurality of transaction options associated with a second plurality of events for constructing a series including the first transaction option and a second transaction option of the second plurality of transaction options.

17. The computing system of claim 16, wherein the processor is further configured to determine a probability associated with each of the second plurality of transaction options.

18. The computing system of claim 16, wherein the processor is further configured to determine a transaction probability associated with the second transaction option and a cumulative probability associated with the first transaction option and the second transaction option.

19. The computing system of claim 16, wherein the processor is further configured to use the cumulative probability to determine a potential prize pool payout associated with the second transaction option.

20. The computing system of claim 16, wherein the processor is further configured to:
determine a size of a progressive prize pool; and
determine a projected tier associated with the second transaction option, wherein the potential prize pool payout is determined based on one or more of the size of the progressive prize pool and the projected tier.
